(19) United States
(12) Patent Application Publication
(10) Pub. No.: US 2024/0228239 A1
(43) Pub. Date: Jul. 11, 2024

(54) DETERMINING POSITION OF A CONTAINER HANDLING EQUIPMENT

(71) Applicant: Konecranes Global Corporation, Hyvinkää (FI)

(72) Inventor: Ville MANNARI, Hyvinkää (FI)

(21) Appl. No.: 18/558,942

(22) PCT Filed: May 9, 2022
(86) PCT No.: PCT/FI2022/050311

§ 371 Date: Nov. 3, 2023

(30) Foreign Application Priority Data
May 10, 2021 (FI) 20215550

(51) Int. Cl. B66C 13/46; B66C 15/04; G01S 17/88

(52) U.S. Cl. CPC B66C 13/46; B66C 15/045; G01S 17/88

(57) ABSTRACT

A method comprising obtaining data from one or more lidars that are installed beneath a trolley comprised in a gantry crane such that the one or more lidars provide a field of view that enables detection of a spreader and a load that is located beneath the spreader, determining, based on the obtained data, a position of the spreader comprised in the gantry crane and configured to be moved by the trolley, and monitoring the environment around the spreader during loading or unloading the load to which the spreader is capable of gripping to.

### TECHNICAL FIELD

The present application relates to gantry cranes and to automating at least some functionality of gantry cranes.

### BACKGROUND

Gantry cranes are utilized in various environments to move loads such as containers. For example, gantry cranes may be utilized to move containers within the area and to load those for further transportation. To increase efficiency, automation may be desirable for such container handling areas. Yet, the automation may need to be compatible with manual operations as well and it needs to be reliable such that safety of a container handling area is not compromised. If automation is added to a container handling area that has been operating already and which is to be updated, updates regarding automation are to be compatible with other, already existing functionalities within the container handling area.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to one aspect, there is a method comprising obtaining data from one or more lidars that are installed beneath a trolley comprised in a gantry crane such that the one or more lidars provide a field of view that enables detection of a spreader and a load that is located beneath the spreader, determining, based on the obtained data, a position of the spreader comprised in the gantry crane and configured to be moved by the trolley, and monitoring the environment around the spreader during loading or unloading the load to which the spreader is capable of gripping to.

According to another aspect there is a gantry crane comprising a trolley, a spreader and one or more lidars installed beneath the trolley on opposite sides of the trolley and wherein the gantry crane is caused to obtain data from one or more lidars that are installed beneath a trolley comprised in a gantry crane such that the one or more lidars provide a field of view that enables detection of a spreader and a load that is located beneath the spreader, determine, based on the obtained data, a position of the spreader comprised in the gantry crane and configured to be moved by the trolley, and monitor the environment around the spreader during loading or unload the load to which the spreader is capable of gripping to.

According to another aspect there is provided a non-transitory computer readable medium comprising program instructions for causing an apparatus to perform at least the following: obtain data from one or more lidars that are installed beneath a trolley comprised in a gantry crane such that the one or more lidars provide a field of view that enables detection of a spreader and a load that is located beneath the spreader, determine, based on the obtained data, a position of the spreader comprised in the gantry crane and configured to be moved by the trolley, and monitor the environment around the spreader during loading or unload the load to which the spreader is capable of gripping to.

### BRIEF DESCRIPTION OF THE DRAWINGS

FIGS. 1A and 1B illustrate an exemplary embodiment of a gantry crane comprising two multi-layer lidars installed beneath a trolley.

FIG. 2 illustrates an exemplary embodiment of calibrating values representing spreader position of a gantry crane comprising two multi-layer lidars installed beneath a trolley.

FIGS. 3A and 3B illustrate an exemplary embodiment in which a truck loading area is monitored.

FIG. 3C illustrates an exemplary embodiment of detecting twistlocks.

FIG. 4 illustrates an exemplary embodiment of a computing apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

A gantry crane may be understood as a container handling equipment that comprises a horizontal bridge that is placed on top of at least two legs thereby forming a shape resembling a door frame. It is to be noted that also other shapes, such as a triangular type of a shape, are possible. The horizontal bridge may comprise one or more beams and there may be a trolley running along the horizontal bridge. The trolley is then connected to a spreader that may be understood as a device used for lifting loads such as containers or other unitized cargo. The spreader may comprise a locking mechanism to attach to items such as a container. For example, the spreader may comprise a locking mechanism at each corner enabling it to attach to four corners of a container. The trolley may then move the spreader horizontally along the bridge between the legs, that may be considered as vertical support structures of the gantry crane. As the load may also be lifted and lowered, the gantry crane may move the load around the load handling area.

It is to be noted that various types of gantry cranes exist for various purposes. If a gantry crane is for container handling and is to be used in a container handling area, for example in a container terminal, the gantry crane may be for example an automatic stacking crane, ASC, a rubber-tyred gantry crane, RTG crane, or a rail mounted gantry crane, RMG crane. RTG cranes may move within a container handling area on rubber tyres and RMG cranes may move along rails. RMG cranes may be with or without a cantilever. This way the gantry cranes may move the loads also in another manner than along to horizontal bridge and take containers from one place to another.

Automating a gantry crane may be achieved by automating one or more actions of the gantry crane or it may be automated fully. Yet, to achieve compatibility with other devices and functions within a container handling area, it is beneficial to automate one or more actions of a gantry crane such that it still remains compatible with manual operation to achieve the desired actions of the gantry crane. Automating one or more actions of the gantry crane may be achieved for example by using a set of 2D lasers scanners or swivelling 2D laser scanners to scan the environment around the spreader. This way it may be possible to detect if there are obstacles in the environment such that collisions are to be avoided and then the movement of the trolley, lowering or lifting the load, and/or movement of the gantry crane may be adjusted accordingly. Also, the target area for the load may be detected in this manner. Yet, 2D lasers provide a limited view of the environment thereby introducing restrictions regarding the type of load that may be handled and how reliably and thoroughly the environment may be detected. For example, if there is a misplaced container within the container handling area, nearby the gantry crane, the misplaced container may go undetected thereby introducing possible safety concerns.

If swivelling 2D lasers are used with a servo motor, a 3D point cloud of the surrounding environment may be produced. Such a 3D presentation may provide an accurate representation of the environment, but scanning the environment takes time, for example several seconds, which may be too much if real-time monitoring of the environment is to be achieved. Further, calibrating one or more swivelling 2D lasers with servo motors such that those are compatible with other measurement systems used may be cumbersome.

A lidar, such as a multi-layer lidar, may be understood as a device that allows measuring distances by illuminating a target area with laser light and then measures the reflection with a sensor. A multi-layer lidar may scan the target area in multiple planes. Detected differences in return times and wavelengths are then utilized for creating a 3D point cloud that represents the target area in real time. Software algorithms may then be utilized to determine from the 3D point cloud what the environment is like and are there landmark objects, obstacles to avoid and so on. The software algorithms may be executed by a computing apparatus that may be comprised in the multi-layer lidar or the computing device may be connected to the multi-layer lidar. Multi-layer lidars may have different functionalities and the functionalities may vary between different multi-layer lidars. For example, a multi-layer lidar may have a 0.18-degree resolution in both horizontal and vertical direction and the multi-layer lidar may offer a measurement range of 80 m at 10% reflectivity. As mentioned, other multi-layer lidars may have differing capabilities.

It is to be noted that various types of lidars may be utilized in addition to multi-layer lidars. For example, in some exemplary embodiments a lidar, such as a solid state lidar, may have a field of view such as greater than 70 degrees and/or detection range that adjusts according to the intensity of the ambient light. A lidar may have a performance that achieves a point cloud range of 2400 000 points per second for example. The scanning of the environment may be done for example using layers. Alternatively, or additionally, the scanning may be performed such that scanning is performed in a non-repetitive manner. In a non-repetitive scanning, the scanning may be performed in a circular shape such that the scans form a shape that resembles a flower. Non-repetitive scanning may have a benefit of improving detection of objects and details within the field of view of the lidar. Further alternatively, or additionally, repetitive line scanning may be utilized. In a repetitive line-scanning manner a benefit of more efficient mapping of scenarios that require high precision and point cloud distribution may be achieved.

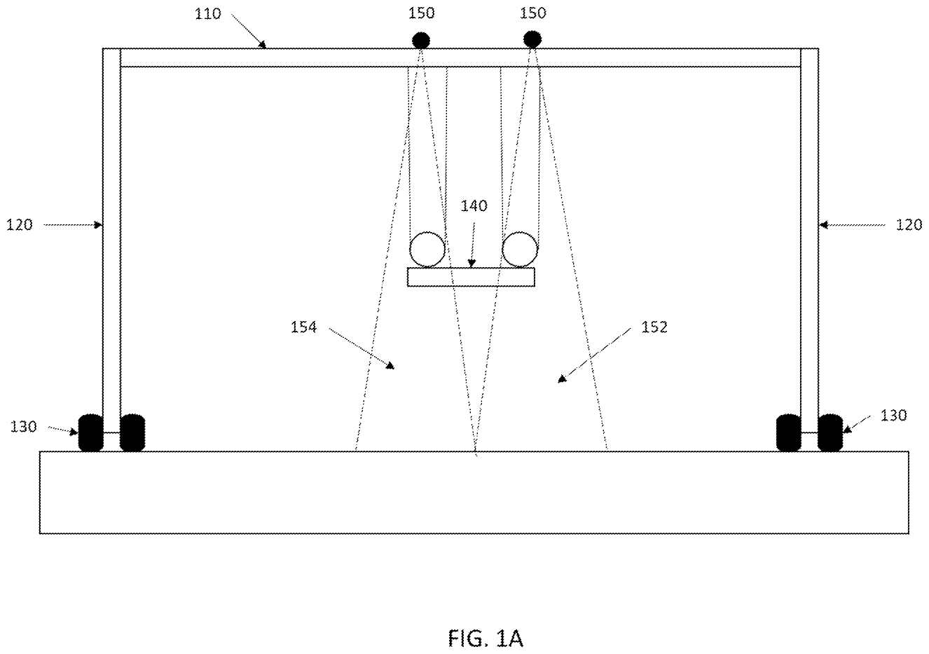

FIGS. 1A and 1B illustrate an exemplary embodiment in which there are two multi-layer lidars 150 installed in a gantry crane. The gantry crane in this exemplary embodiment comprises a horizontal beam 110, legs 120 that are vertical supporting structures, and rubber tyres 130. The gantry crane also comprises a spreader attached to hoisting means 140. In this exemplary embodiment, the multi-layer lidars 150 are installed in both sides of the trolley such that each scan layer of the multi-layer lidars is parallel to the driving direction of the gantry crane, which in this exemplary embodiment is an RTG crane. It is to be noted that in some exemplary embodiments lidars may have different scanning patterns. For example, the scan may resemble a flower-like pattern as described above. The field of view of the multi-layer lidars 150 are illustrated as 152 and 154 and the angle of the field of view in this exemplary embodiment is 22 degrees, but in some other exemplary embodiments the field of view may have a different angle. In FIG. 1A side view of the field of views of the multi-layer lidars 150 is illustrated. In this exemplary embodiment, the multi-layer lidars 150 are capable of detecting containers located underneath as well as on adjacent container slots in the direction of the gantry and in the direction of the trolley. This detecting may be done in real-time or at least in near real-time due to the usage of the multi-layer lidars 150. FIG. 1B illustrates a top view of the field of views of the multi-layer lidars 150 placed beneath the trolley.

In this exemplary embodiment, the multi-layer lidars 150 are installed beneath the trolley such that they are located on opposite sides of the trolley. The field of views 152 of the multi-layer lidars 150 in this exemplary embodiment form a continuous field of view. Alternatively, the field of views 152 could also be, at least partly, overlapping or there could be a discontinuing part between the field of views. It is also to be noted that the placement of the multi-layer lidars beneath the trolley may be different in different exemplary embodiments. Placement underneath the trolley may therefore vary and there may be more than two multi-layer lidars installed beneath the trolley such that the space required around the spreader is not increased due to the placement of the multi-layer lidars. It is to be noted that in some exemplary embodiments, there may also be one lidar, or a plurality of lidars, that are installed beneath the trolley such that the one or more lidars provide a field of view that enables detection of at least to the spreader, one or more load, such as a container, beneath the spreader and/or to one or more adjacent objects such as containers. If one lidar is to be used, that may, in some exemplary embodiments, restrict possibilities to fully monitor the surrounding environment. Yet, the monitoring may be sufficient to achieve automatic stacking.

As the multi-layer lidars 150 are placed beneath the trolley, no extra space is needed around the spreader. If the multi-layer lidars were to be placed on the spreader, then extra space would be required around the spreader. This could result in a situation in which 450 mm of extra space, due to for example fencing required around the multi-layer lidars, is required between containers to enable the usage of the multi-layer lidars. Yet, often container handling areas, such as container terminals have 350 mm reserved between containers and therefore automation that would require the space between containers to be increased is not practical, nor desirable.

In this exemplary embodiment the multi-layer lidars support 128 layers, though in some other exemplary embodiments there may be a different amount of layers may be supported. From the data, which is provided by the multi-layer lidars, containers may be recognized using one or more software algorithms or by a user looking at the data or using a combination of both. Also, a spreader about to land on a container may be detected based on the data for example.

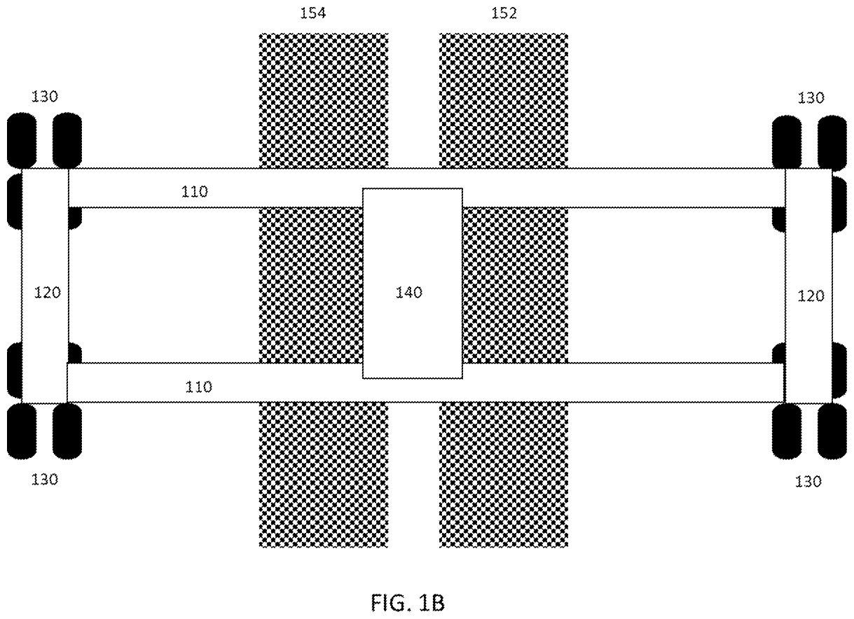

FIG. 2 illustrates calibrating values representing spreader position when a gantry crane having at least two multi-layer lidars installed beneath the trolley is used. Uncalibrated values are illustrated by 210 and calibrated values by 220. First an installation angle is measured by lowering the spreader one meter at a time and then stopping the spreader. The dots represent the measured value at each stop. The lowering and stopping of the spreader is repeated until the spreader is lowered all the way down. Using this procedure, a set of XYZ values and skew-points for each sensor used for detecting the environment around the gantry crane are obtained. After this a linear regression is used to fit a plane to the measurements and a line obtained this way may be used to define a sensor angle and offsets.

When a gantry crane comprising at least two multi-layer lidars installed beneath the trolley is used, to move load such as containers, a target for landing the load may be detected either fully automatically or with some input from a user. When a landing position for the load is to be determined, data received from the at least two multi-layer lidars may be analyzed. It is to be noted that for the analysis, the data received from the at least two multi-layer lidars may be combined using for example mathematical methods and the combined data is then analyzed. Alternatively, data received from one multi-layer lidar may be analyzed individually and the result may then be combined with results of analysis performed for data received from other multi-layer lidars. For example, one or more software algorithms for edge and/or corner detection may be used. Such algorithms may be executed by a computing apparatus that may be comprised, or be connected to, the multi-layer lidars or the gantry crane. Additionally, or alternatively, as accurate 3D positioning is achieved by using the two or more multi-layer lidars, corner castings and/or twistlocks may also be detected, using one or more software algorithms and/or input from a user, which may enable handling of special containers. It is to be noted though that accurate 3D positioning may also be achieved using one or more lidars in some other exemplary embodiments. It is also to be noted that when the load is being landed, the landing position may be determined continuously.

Further, the usage of the at least two multi-layer lidars allows detecting, from the data provided by the at least two multi-layer lidars, markings such as markings on the ground indicating a slot for a container. The markings may be detected for example based on the received signal strength of the laser pulse. The markings may be of light colour, such as white, which causes the reflected signal to be stronger than the surrounding dark ground. Additionally, or alternatively, surrounding containers may also be detected and, in some exemplary embodiments, doors left open may also be detected. In addition to doors, which may be doors of containers, also doors of vehicles used to transport one or more containers may be left open and that may be detected. It is possible that the surrounding environment comprises unintended items such as containers that are not in a place they were intended to be. To be able to detect such items allows prevention of collisions and adaptation of a target landing position instead of relying solely on mapped location and the containers underneath when determining a target location of a load being moved by the gantry crane. The data provided by one or more multi-layer lidars thus allows this real-time reaction to the environment that may be automated using one or more software algorithms or it may also involve at least some user input. When determining, which may be understood also as calculating, the target landing position, one or more software algorithms may be executed using a computing apparatus that is comprised in or connected to the gantry crane and/or the multi-layer lidars.

As the multi-layer lidars provide data regarding the environment from the viewpoint that is beneath the trolley, the spreader may also be included in the data. Therefore, the spreader is to be detected in order to make accurate and reliable calculations regarding the environment and/or the landing position for the load being moved by the gantry crane. Any suitable algorithms may be used to determine the spreader and the algorithms may utilize knowledge of known physical structures of the spreader and/or the shape of additional known structures placed on the spreader. This allows also to determine the position of the spreader in relation to the multi-layer lidars.

As the usage of the multi-layer lidars allows detecting in real-time if there is enough space around the spreader on both sides, it may still happen in that in some situations for example the short side of the spreader cannot be fully monitored. To address the possibility of such a situation, the side profile of the spreader may be stored in memory of a computing apparatus comprised in or connected to the multi-layer lidars and/or the gantry crane. This storing may take place before the view to the short side is blocked.

It is to be noted that there may also occur situations in which an opening angel used in the multi-layer lidars sets restrictions regarding stack collision prevention. Due to these restrictions, the speed of the trolley may have to be limited in such situations.

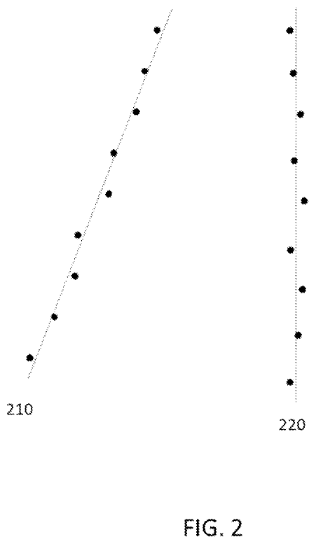

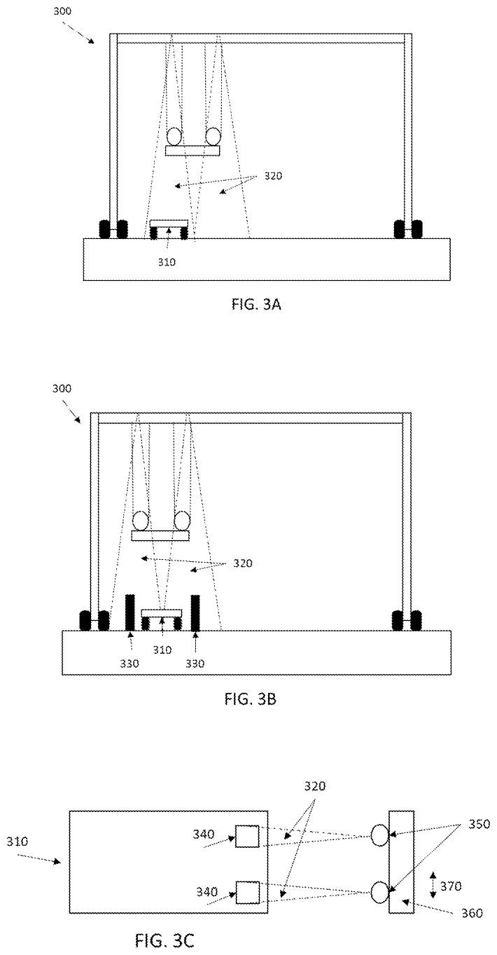

FIGS. 3A and 3B illustrate an exemplary embodiment in which a truck loading area is being monitored. A truck 310 may have a dedicated lane to which the truck 310 parks in order to be loaded with a container that is moved by a gantry crane 300. The driver of the truck 310 may park the truck 310 to a specific location and then, for reasons of safety, step out of the truck for the duration of loading of the container. Yet, it also happens that for example with RTG operations, there is no safe location outside the truck for the driver to go to for the duration of loading/unloading and the driver is to stay within the cabin of the truck during the loading/unloading. In this exemplary embodiment, the gantry crane comprises two multi-layer lidars installed beneath the trolley as is described in the previous exemplary embodiments. In this exemplary embodiment, optionally, the cabin is monitored to ensure it is not getting under the load when the trolley is about to move to the truck lane. Optionally, twistlock detection and determining the landing position for the container may be assumed to be obtained from a system connected to the gantry crane and/or the multi-layer lidars.

Alternatively, or additionally, the detection of the twistlocks in combination with detecting borders, that may be comprised for example in a truck used internally in a container handling area, and/or determining the landing position may be done using the data obtained from the multi-layer lidars, which may also enable automatic handling of internal chassis as well.

In FIGS. 3A and 3B the field of view 320 of the two multi-layer lidars installed beneath the trolley is illustrated. In the FIG. 3A, the trolley has not yet moved the load to the top of the truck lane and the field of view of the multi-layer lidars allows monitoring the truck cabinet will not be in danger of getting under the load. If it is determined that the truck cabinet is not in danger of getting under the load, the trolley is automatically driven on to the truck lane.

In FIG. 3B areas 330 around the truck 310 are illustrated. These are areas that are to be monitored by the multi-layer lidars during the loading of the truck to ensure that there is no movement in those areas during the loading and/or that the truck 310 itself does not move during the loading or in some other exemplary embodiments, during the unloading of the truck 310. If it is detected that there is movement around the truck or that the truck 310 itself moves during the loading, the loading process may be stopped. Further, an indication of this may be provided to for example a monitoring system. Additionally, the door of the truck cabinet may also be monitored and if its movement is detected, the process may be stopped and optionally an indication may also be provided to the monitoring system.

It is to be noted that the data obtained from the multi-layer lidars may be provided to a remote monitoring system in which it may be used to enhance 2D data obtained from one or more cameras monitoring the area around the gantry crane. This way the 2D data may be enhanced with real-time 3D perception obtained from the data provided by the multi-layer lidars.

Further, as the multi-layer lidars are able to observe the environment around the gantry crane in real-time and in 3D, this may be utilized to calculate optimized trajectories in 3D by a computing apparatus that is comprised in or connected to the gantry crane. Thus, optimized gantry-trolley-hoist trajectories may be obtained, which may have the benefit of improving cycle times and overall performance of the port.

It is also to be noted that the multilayer lidars may be utilized for monitoring movement around a spreader. Such monitoring may occur for example if the spreader is empty, that is not carrying a load due to for example the spreader being moved towards a load to be picked up. Such monitoring may also take place if the spreader is being used to move a load. If the spreader is being used to move a load, that is the spreader has picked up a load, then the load may block, at least partly, the field of view of the monitoring. This may be taken into account also when lowering the load, which may be done onto a floor thereby starting a new stack, onto another load or onto a vehicle. The load may be a container for example.

FIG. 3C illustrates an example embodiment, in which a container is to be loaded onto the truck 310 by the gantry crane. In this exemplary embodiment, there are multi-layer lidars 350 that are placed on a trolley 360, for example, on the opposite sides of the trolley 360, and the trolley 360 has not been lowered, or has not been lowered significantly and is thus substantially up. The trolley 360 may be moved 370 along a horizontal beam of the gantry crane. The horizontal beam may be a main beam, or it may be a horizontal beam parallel to the main beam. Moving 370 the trolley 360 along a horizontal beam may help to improve accuracy of the data obtained from the multi-layer lidars 350 as the moving 370 may allow each multi-layer lidar 350 to have a better field of view 320 downwards towards the target area, which comprises the truck 310 that is to be loaded. For example, if the gantry crane is to load the truck 310 with a container, when lowering the container, the trolley 360 may be moved 370 along the horizontal beam thus allowing the multi-layer lidars 350 to obtain better field of view 320 to the target place for the container. This may not significantly increase the lowering time as lowering the container in any case takes some time. Yet, this way the multi-layer lidars 350 are able to provide data from which the twistlocks 340 can be detected with better accuracy. It may be sufficient to detect two twistlocks 340 with sufficient accuracy as if the position and orientation of the container is known and can be controlled such that the container can be loaded onto the truck 310 accurately.

In some exemplary embodiments, some of the functionalities described above could be available only if it is determined that the user has an authentication to access the functionality. Such case may ensure that only right users are able to access the functionality or that a proper license has been obtained by the user to access functionality. The access rights, which in some exemplary embodiments may be obtained by purchasing user rights and/or by determining that the user is qualified to obtain the access rights, may allow automation functionality to be activated without having to introduce changes to hardware.

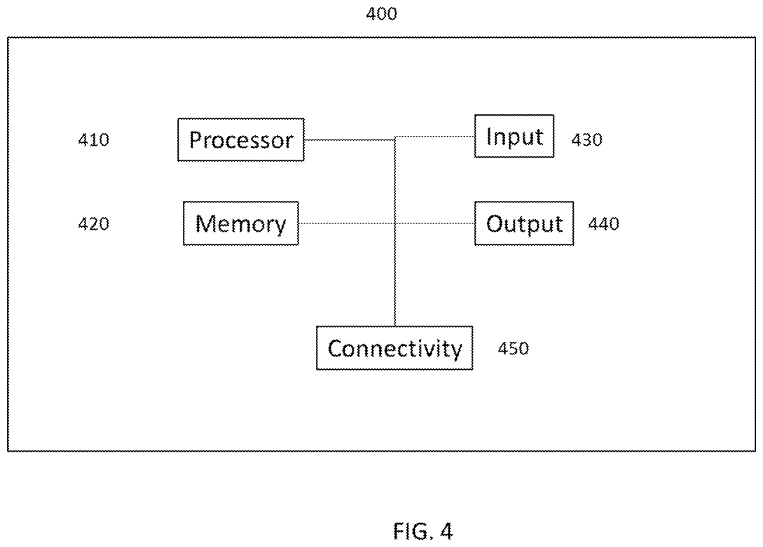

FIG. 4 illustrates an exemplary embodiment of a computing apparatus 400. The computing apparatus may be comprised in or connected to a gantry crane or a multi-layer lidar. The computing apparatus 400 comprises a processor 410. The processor 410 interprets computer program instructions and processes data. The processor 410 may comprise one or more programmable processors. The processor 410 may comprise programmable hardware with embedded firmware and may, alternatively or additionally, comprise one or more application specific integrated circuits, ASICs.

The processor 410 is coupled to a memory 420. The processor is configured to read and write data to and from the memory 420. The memory 420 may comprise one or more memory units. The memory units may be volatile or non-volatile. The memory 420 further stores computer readable instructions that are execute by the processor 410. For example, non-volatile memory stores the computer readable instructions and the processor 410 executes the instructions using volatile memory for temporary storage of data and/or instructions. The memory may also save data such as values.

In the context of this document, a memory or computer-readable media may be any non-transitory media or means that can contain, store, communicate, propagate or transport the instructions for use by or in connection with an instruction execution system, apparatus, or device, such as a computer.

The computing apparatus 400 further comprises, or is connected to, an input unit 630. The input unit 630 comprises one or more interfaces for receiving input such as user input. The computing apparatus 400 also comprises an output unit 440. The computing apparatus 400 may further comprise a connectivity unit 450. The connectivity unit 450 enables wired and/or wireless connectivity to external networks such as Bluetooth or Wi-Fi.

It is to be noted that the computing apparatus 400 may further comprise various component not illustrated in the FIG. 4. The various components may be hardware component and/or software components.

The exemplary embodiments described above may have various benefits. For example, being compatible with existing container handling terminals without a need to change container spacing. Further, parallel manual and automated operation is enabled as well as simplifying monitoring by allowing the number of sensors required for monitoring to be reduced. Also, the exemplary embodiments described above may enable automatic calibration of routines. Even further, the spacing between containers may be reduced and/or special containers, such as tank containers may also be handled by the exemplary embodiments described above.

Even though the invention has been described above with reference to exemplary embodiments according to the accompanying drawings, it is clear that the invention is not restricted thereto but can be modified in several ways within the scope of the appended claims. Therefore, all words and expressions should be interpreted broadly, and they are intended to illustrate, not to restrict, the embodiment. It will be obvious to a person skilled in the art that, as technology advances, the inventive concept can be implemented in various ways. Further, it is clear to a person skilled in the art that the described exemplary embodiments may, but are not required to, be combined with other exemplary embodiments in various ways. The scope of protection sought for various embodiments of the invention is set out by the independent claims. If any exemplary embodiments and features described in this specification should not fall under the scope of the independent claims, those are to be interpreted as examples useful for understanding various embodiments of the invention.

1. A method comprising:
obtaining data from one or more lidars that are installed beneath a trolley comprised in a gantry crane such that the one or more lidars provide a field of view that enables detection of a spreader and a load that is located beneath the spreader;
determining, based on the obtained data, a position of the spreader comprised in the gantry crane and configured to be moved by the trolley; and,
monitoring the environment around the spreader during loading or unloading the load to which the spreader is capable of gripping to.

2. The method according to claim 1, wherein the method further comprises determining based on the obtained data a target landing position for the load.

3. The method according to claim 2, wherein the target landing position is determined continuously when the load is being landed.

4. A The method according to claim 1, wherein the method further comprises monitoring movement around the spreader.

5. The method according to claim 4, wherein the monitoring further comprises providing an indication if movement is detected based on the obtained data.

6. The method according to claim 1 further comprising providing the obtained data to a monitoring system.

7. A The method according to claim 1, wherein the method further comprises calculating optimized trajectories in 3D based on the obtained data.

8. A The method according to claim 1, wherein the method further comprises detecting one or more containers from the obtained data.

9. A The method according to claim 1, wherein the method further comprises detecting corner castings and/or twistlocks of the load based on the obtained data.

10. The method according to claim 1, wherein the method further comprises detecting an open door based on the obtained data.

11. The method according to claim 1, wherein a side profile of a short side of the spreader is stored in a memory of a computing apparatus.

12. The method according to claim 1, wherein the method further comprises calibrating values representing the position of the spreader based on at least partly automated cycle.

13. A gantry crane comprising a trolley, a spreader and one or more lidars installed beneath the trolley and wherein the gantry crane further comprises means for performing the method according to claim 1.

14. (canceled)

15. A computer program product comprising instructions for causing an apparatus to perform the method according to claim 1.

16. The gantry crane according to claim 13, wherein the gantry crane is a rubber tyred gantry crane or an automatic stacking crane.
